(19) United States
(12) Patent Application Publication
(10) Pub. No.: US 2016/0158831 A1
(43) Pub. Date: Jun. 9, 2016

(54) SALT CORES AND ADDITIVE MANUFACTURING METHOD FOR PRODUCING SALT CORES

(71) Applicant: EMIL MÜLLER GMBH, Wilhermsdorf (DE)

(72) Inventor: Thorsten HARTIG, Puschendorf (DE)

(21) Appl. No.: 14/906,839

(22) PCT Filed: Jul. 24, 2014
(86) PCT No.: PCT/EP2014/065934

§ 371 Date: Jan. 21, 2016

(30) Foreign Application Priority Data
Jul. 24, 2013 (DE) 102013214467.9
Mar. 10, 2014 (DE) 102014204304.2

(51) Int. Cl. B22C 9/10; B22C 1/10; B22C 9/12; B22C 1/22

(52) U.S. Cl. CPC B22C 9/105; B22C 1/22; B22C 1/10; B22C 9/12; B33Y 70/00

(57) ABSTRACT

The invention relates to salt cores for producing castings, which salt cores have a layered structure and can be produced by means of an additive manufacturing method. Salt is preferably used as a molding material, the salt being applied in layers and being supplied with a binder.

The invention relates to salt cores as cavity placeholders in castings and/or plastic molded parts and to methods for producing such salt cores. In particular, the invention relates to salt cores that can be produced by means of additive methods.

The preferred field of use for such salt cores is all casting methods for light metals and nonferrous heavy metals and production methods for plastics and/or carbon-fiber- and glass-fiber-reinforced components.

In the context of this invention, the term “castings” comprises not only metal components but also all other components that are produced by casting or injection molding or similar methods and require a casting core. In particular, injection-molded plastic parts should also be comprised by this term.

In the case of many products produced by casting, it is necessary to produce cavities in the interior or undercuts in the exterior region. In the unpressurized methods, such as gravity casting, a core composed of consolidated sand or salt is positioned within the mold and overcast with metal melt. In the process, the casting mold is filled and the core is surrounded with melt.

Dry-pressed salt cores have been in use in founding for decades. This known manufacturing method is used for products having simple geometries.

A further production method for salt cores is core shooting. By means of core shooting, salt cores having significantly more complex geometries can be reliably produced. Both methods, dry pressing and core shooting, have the disadvantage that a primary shaping tool is always required. The production of primary shaping tools is complex, time-intensive, and costly. Furthermore, primary shaping tools are subject to manufacturing wear.

In addition, the production of single-part molds and cores having undercut contours is not possible with respect to molding.

The production of pressed cores having complex geometries is not possible in one operation, but rather can be achieved only by means of downstream process steps.

The problem addressed by the invention is that of providing salt cores having complex geometries and providing a method for producing such salt cores.

This problem is solved by means of salt cores according to claim 1 and by means of a method according to claim 8. Advantageous developments of the subject matter of the invention can be found in the dependent claims.

Accordingly, a salt core according to the invention is distinguished in that said salt core has a layered structure. This layered structure consists of or comprises individually applied and consolidated layers of a molding material.

A method according to the invention for producing salt cores differs from methods known from the prior art in that the salt cores can be produced without the use of primary shaping tools in that salt particles applied in layers are connected to each other by the selective application/spraying on of binder.

According to an especially preferred embodiment of the invention, the salt cores are soluble in a solvent and in particular are water-soluble.

The cores according to the invention comprise a molding material, preferably crystalline salt particles, binders, and possibly auxiliary materials such as filling materials, additives, wetting agents, hardeners, and catalysts.

The salt cores are produced by means of an additive manufacturing method. Especially preferred is the method of 3-D printing of salt, wherein the salt particles are consolidated by means of a binder liquid or a hardener locally, in accordance with the 3-D data model. In this method, the advantages of core shooting and of dry pressing are combined with each other.
High complexity of the mold/of the core can be realized by means of the construction in layers. Hollow structures can also be produced.
Economical and substantially biologically/ecologically harmless salts can be used for the 3-D printing of the salt cores.
The build-up of the individual salt particles into a salt core or a mold occurs by computer-controlled, selective spraying/application of binder or hardener onto a thin molding material layer, which is applied to a support. After the layer has been consolidated, the support is moved/lowered and a new molding material layer is applied and again consolidated by means of binder/hardener. The selective application of the binder must be repeated for each newly applied molding material layer.
No warping at the component arises due to the construction in layers and the local application of the binder.
The porosity/gas permeability of the produced cores/molds can be set in a specific manner.
Simple removal of the cores without residue, because the cores can be composed exclusively of water-soluble components
High flexibility and speed in the case of small series and prototypes
No tool costs

Crystalline salt is preferably used as a molding material for the salt cores described here. The crystalline salt can have a unimodal grain size distribution or a bi- or multimodal grain size distribution. A bi- or multimodal grain size distribution can be advantageous with regard to especially tight packing of the crystals. The porosity present in the salt cores according to the invention can thus be varied. The salt cores according to the invention have a residual porosity of less than 30%, preferably of less than 5% and particularly preferably of less than 2%, with respect to the total volume of the salt core.

Important selection criteria for the salts to be used are the toxicity and solubility thereof.

For example, chlorides, sulfates, phosphates, or nitrates of the alkali, alkaline-earth, or subgroup elements, or mixtures of said salts, particularly sodium chloride, potassium chloride, magnesium chloride, and/or potassium sulfate, magnesium sulfate, ammonium sulfate, sodium sulfate can be used as salts or molding material.

A method according to the invention for producing such salt cores is distinguished in that the salt molds and salt cores are constructed in layers.

According to a preferred embodiment of the invention, the salt core can be designed hollow, wherein the interior of the salt core can be empty or filled. The hollow salt core can preferably be filled with the unconsolidated molding material.

Especially preferably, the salt core consists of an additively produced, consolidated surface shell, while the inner molding material portion surrounded by the consolidated surface shell is not consolidated.

The salt core produced by 3-D printing can be coated with a water-soluble facing or infiltrated with a salt melt in order to close open pores that are close to the surface.

It was found that it is possible to insert and mount a multitude of functional parts, which are used to produce, for example, transmissions, drive elements, pumps, channels, and pipe systems, into a hollow molded body not only after the end of the production of said hollow body, but rather to insert these functional parts into a water-soluble salt core, which is then overcast with metal or plastic in a casting method. Thereafter, the water-soluble salt core is rinsed out and the functional parts are already present in the desired position and function in the hollow molded body.

Such a salt core comprises a component, particularly selected from gears, transmission parts, shaft elements, or drive elements, in form-closed connection in such a way that no back-casting with melt and no flake formation occur when the overcasting is performed. The component is completely or partially surrounded by the salt core. In general, only the shafts or shaft bearings protrude from the salt core or lie at the surface of the salt core.

Furthermore, the method according to the invention is distinguished in that the molding material is a powdery, granular, or granulated salt or a mixture of salts having round, irregularly shaped or angular, splintery crystals.

According to a preferred embodiment of the invention, the grain size of the crystalline salt lies in the range of 0.01 mm to 2 mm, Especially preferred grain size ranges lie between 0.01 and 0.29 mm, between 0.3 and 1.3 mm, and/or between 1.31 and 2.0 mm, wherein the first two fractions can be used as rather fine-grained salt and the last fraction can be used as rather coarse-grained salt in mixtures of multimodal composition.

In a further embodiment of the invention, the molding material is applied and supplied with a cold-, warm-, or hot-curing binder in layers. Especially preferably, the molding material is sprayed with the binder so that the molding material is bonded to form a salt core/body in accordance with the specified data model. The binder is cured.

A further preferred method provides that the molding material, i.e., in particular the crystalline salt particles, is covered with a hardener. This molding material covered with a hardener is then applied to a support and supplied with a binder in layers. Here as well, the supplying comprises in particular the spraying with a binder in regions specified by the data model.

Especially preferably, resins from the group of the phenolic resins, phenol-urea-formaldehyde resins, the nitrogen-free or low-nitrogen phenol-formaldehyde resins, the phenolic resins containing furfuryl alcohol, furfuryl alcohol-urea-formaldehyde resins, the furan resins, the phenol-modified furan resins, the amino resins, the novolacs, or the resols, which resins can be used in liquid or solid form, are used as a binder.

A further preferred embodiment provides for water-soluble silicate compounds, particularly water glasses, as a binder. Water glasses having a water glass modulus of 1 to 5 and/or a mixture of water glasses having different water glass moduli can be used.

If an additional hardener is used, the fraction thereof is preferably between 0.5 and 30 wt %, especially preferably between 0.5 and 15 wt %, with respect to the mass of the binder.

In order to achieve complete hardening of the salt cores thus produced or also outgassing of volatile constituents of binder and/or hardener, it can be advantageous in certain cases to post-harden the salt cores in a furnace.

In summary, a method according to the invention in accordance with the especially preferred 3-D printing can look as follows, i.e., can comprise the following steps:
Producing a data model of the salt core to be produced
Preparing a molding material, consisting of salt particles, possibly a binder, and/or possibly a hardener
Applying a thin molding material layer to a movable support
Spraying the molding material layer with a hardener and/or a binder in regions corresponding to the data model in a computer-controlled manner
Moving the support
Applying a molding material layer again and spraying the molding material layer, until the produced salt core corresponds to the data model
Possibly post-hardening the salt core in a furnace

1.-15. (canceled)

16. A salt core for producing castings comprising a salt and having a layered structure, wherein the layered structure comprises of individually applied and consolidated layers of a molding material.

17. The salt core according to claim 16, wherein the molding material comprises salt particles, particularly crystalline salt and/or a binder.

18. The salt cores according to claim 17, wherein the crystalline salt is contained in a unimodal, bimodal, or multimodal grain size distribution, the crystalline salt preferably having grain sizes in the range of 0.01 mm to 2 mm.

19. The salt core according to claim 16, wherein the salt core comprises at least one component, in particular selected from gears, transmission parts, shaft elements, or drive elements, in form-closed connection in such a way that no back-casting with melt and no flake formation occur when the overcasting is performed, the component being completely or partially surrounded by the salt core.

20. The salt core according to claim 16, wherein the salt core is hollow, it being possible that the interior of the salt core is empty or filled with unconsolidated molding material.

21. The salt core according to claim 16, wherein the salt core is coated with a water-soluble facing or is infiltrated with a water-soluble salt melt.

22. A method for producing salt cores, wherein the salt cores are produced by means of an additive manufacturing method, particularly by means of 3-D printing.

23. The method according to claim 22, wherein the salt cores are produced from a molding material, salt particles, being used as the molding material.

24. The method according to claim 23, wherein the molding material is applied and supplied, particularly sprayed, with a cold-, warm, or hot-curing binder in layers, and the binder is then cured.

25. The method according to claim 24, wherein a resin from the group of the phenolic resins, phenol-urea-formaldehyde resins, the nitrogen-free or low-nitrogen phenol-formaldehyde resins, the phenolic resins containing furfuryl alcohol, furfuryl alcohol-urea-formaldehyde resins, the furan resins, the phenol-modified furan resins, the amino resins, the novolacs, or the resols, which resin can be used either in liquid or solid form, is used as the binder.

26. The method according to claim 24, wherein the binder comprises water-soluble silicate compounds, preferably water glasses, particularly water glass having a water glass modulus of 1 to 5 and/or a mixture of water glasses having different water glass moduli.

27. The method according to claim 26, wherein the fraction of the hardener lies between 0.5 and 30 wt %, preferably between 0.5 and 15 wt %, with respect to the mass of the binder.

28. The method according to claim 23, wherein only a surface shell is consolidated so that the arising salt core is hollow.

29. The method according to claim 23, wherein the produced salt core is post-hardened in a furnace.

30. The method according to claim 23, wherein the method for the 3-D printing of salt cores comprising the steps of:
producing a data model of the salt core to be produced;
preparing a molding material, consisting of salt particles, possibly a binder, and/or possibly a hardener;
applying a thin molding material layer to a movable support;
spraying the molding material layer with a hardener or a binder in regions corresponding to the data model in a computer-controlled manner;
moving the supporting plate; and
applying a molding material layer again and spraying the molding material layer until the produced salt core corresponds to the data model;

31. The method according to claim 30, further comprising the step of post-hardening the salt core in a furnace.
